(19) United States
(12) Patent Application Publication
(10) Pub. No.: US 2026/0269530 A1
(43) Pub. Date: Sep. 10, 2026

(54) ELECTRICAL CONNECTOR WITH IMPROVED FIRST GROUNDING COMPONENT

(71) Applicant: Dongguan Luxshare Technologies Co., Ltd, Dongguan City (CN)

(72) Inventors: Kunlin Yao, Dongguan City (CN); Huanhuan SHEN, Dongguan City (CN)

(73) Assignee: Dongguan Luxshare Technologies Co., Ltd, Dongguan City (CN)

(21) Appl. No.: 19/285,617

(22) Filed: Jul. 30, 2025

(30) Foreign Application Priority Data
Mar. 10, 2025 (CN) 202510283878.9

(51) Int. Cl. H01R 13/652; H01R 12/71; H01R 13/05

(52) U.S. Cl. CPC H01R 13/652; H01R 13/05; H01R 12/716

(57) ABSTRACT

An electrical connector includes an insulating body, a terminal module and a first grounding component. The terminal module includes a first signal terminal and a first ground terminal. The first ground terminal includes a first elastic arm extending into a mating slot. The first grounding component is at least partially disposed on the insulating body. The first grounding component includes a first contact portion and a second contact portion. The first contact portion extends beyond the second contact portion in a thickness direction of the insulating body. In the first contact portion and the second contact portion, at least the second contact portion is separated from the first elastic arm which is in an unmated state. Both the first contact portion and the second contact portion are arranged to contact the first elastic arm which is in a mated state.

### CROSS-REFERENCE TO RELATED APPLICATION

This patent application claims priority of a Chinese Patent Application No. 202510283878.9, filed on Mar. 10, 2025 and titled “ELECTRICAL CONNECTOR”, the entire content of which is incorporated herein by reference.

### TECHNICAL FIELD

The present disclosure relates to an electrical connector, which belongs to the field of connector technology.

### BACKGROUND

An electrical connector generally includes an insulating body, a plurality of conductive terminals and a shielding plate. Each conductive terminal includes a main body portion, a mating elastic arm extending from the main body portion, and a tail portion extending from the main body portion. The plurality of conductive terminals generally include a signal terminal and a ground terminal. The shielding plate is in contact with the main body portion of the ground terminal to improve the shielding effect.

In related art, in order to increase the grounding effect, the electrical connector provides a grounding component at a position of the mating elastic arm of the ground terminal. The grounding component is mated with the mating elastic arm. During a plug-in process of a mating connector, the grounding component deforms with the deformation of the mating elastic arm. As a result, the grounding component may easily lead to fatigue problems after multiple deformations.

### SUMMARY

The present disclosure discloses an electrical connector, including: an insulating body, the insulating body including a mating surface and a mating slot extending through the mating surface; a terminal module, the terminal module being provided on the insulating body, the terminal module including a first signal terminal and a first ground terminal which is located on one side of the first signal terminal and disposed adjacent to the first signal terminal; the first ground terminal including a first elastic arm extending into the mating slot; the first elastic arm being configured to mate with a mating module; and a first grounding component, the first grounding component being at least partially disposed on the insulating body; the first grounding component including a first contact portion and a second contact portion; the first contact portion extending beyond the second contact portion in a thickness direction of the insulating body; in the first contact portion and the second contact portion, at least the second contact portion being separated from the first elastic arm which is in an unmated state; the first contact portion and the second contact portion being both configured to contact the first elastic arm which is in a mated state.

The present disclosure also discloses an electrical connector, including: an insulating body, the insulating body including a mating surface and a mating slot extending through the mating surface; the mating slot being configured to receive a mating module along a plug-in direction; a terminal module, the terminal module being at least partially coupled to the insulating body, the terminal module including a first signal terminal and a first ground terminal which is located on one side of the first signal terminal; the first ground terminal including a first elastic arm extending into the mating slot; the first elastic arm being configured to mate with the mating module along the plug-in direction; and a first grounding component, the first grounding component being at least partially disposed on the insulating body; the first grounding component including a first contact portion and a second contact portion; the first contact portion and the second contact portion extending in different heights in a thickness direction of the insulating body; the thickness direction being perpendicular to the plug-in direction; wherein in the first contact portion and the second contact portion, when the mating module is in an unmated status with the electrical connector, at least the second contact portion is separated from the first elastic arm; and when the mating module is in a mated status with the electrical connector, the first contact portion and the second contact portion are both configured to contact the first elastic arm.

The present disclosure further discloses an electrical connector, including: an insulating body, the insulating body including a mating surface and a mating slot extending through the mating surface; the mating slot being configured to receive a mating module along a plug-in direction; a terminal module, the terminal module being at least partially coupled to the insulating body, the terminal module including a first signal terminal and a first ground terminal located on one side of the first signal terminal; the first ground terminal including a first elastic arm extending into the mating slot in a cantilevered manner; the first elastic arm being configured to mate with the mating module along the plug-in direction; and a first grounding component, the first grounding component being at least partially disposed on the insulating body; the first grounding component including a first contact portion, a second contact portion and at least one intermediate contact portion disposed between the first contact portion and the second contact portion along the plug-in direction; the first contact portion, the at least one intermediate contact portion and the second contact portion extending in different heights in a thickness direction of the insulating body; the thickness direction being perpendicular to the plug-in direction; wherein the first contact portion extends beyond the at least one intermediate contact portion along the thickness direction, and the at least one intermediate contact portion extends beyond the second contact portion along the thickness direction; wherein the at least one intermediate contact portion and the second contact portion are not in contact with the first elastic arm in a first status when the mating module is not inserted into the mating slot; and wherein the first contact portion, the at least one intermediate contact portion and the second contact portion are configured to be in contact with the first elastic arm in a second status when the mating module is inserted in the mating slot.

### BRIEF DESCRIPTION OF DRAWINGS

FIG. 1 is a perspective schematic view of an electrical connector assembly in accordance with an embodiment of the present disclosure;

FIG. 2 is an exploded schematic view of the electrical connector assembly shown in FIG. 1;

FIG. 3 is an enlarged schematic view of area A in FIG. 2;

FIG. 4 is a perspective schematic view of an insulating body in FIG. 1;

FIG. 5 is an enlarged schematic view of area B in FIG. 4;

FIG. 6 is a perspective schematic view of an electrical connector in FIG. 1 from another angle;

FIG. 7 is an exploded schematic view of the electrical connector shown in FIG. 6;

FIG. 8 is a side view of a terminal module and a grounding component in FIG. 7;

FIG. 9 is an enlarged schematic view of area C in FIG. 8;

FIG. 10 is a side view of the terminal module, the grounding component and a mating module in FIG. 1;

FIG. 11 is an enlarged schematic view of area D in FIG. 10;

FIG. 12 is a perspective schematic view of a first grounding component in accordance with a first embodiment of the present disclosure;

FIG. 13 is a side view of the first grounding component shown in FIG. 12;

FIG. 14 is a top view of the first grounding component shown in FIG. 12;

FIG. 15 is a perspective schematic view of the first grounding component in accordance with a second embodiment of the present disclosure;

FIG. 16 is an exploded schematic view of the terminal module and grounding component in FIG. 2;

FIG. 17 is an exploded schematic view of the first terminal module in FIG. 16;

FIG. 18 is an exploded schematic view of the terminal module and the grounding component in FIG. 7;

FIG. 19 is an enlarged schematic view of area E in FIG. 18; and

FIG. 20 is an exploded schematic view of a fourth terminal module in FIG. 18.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

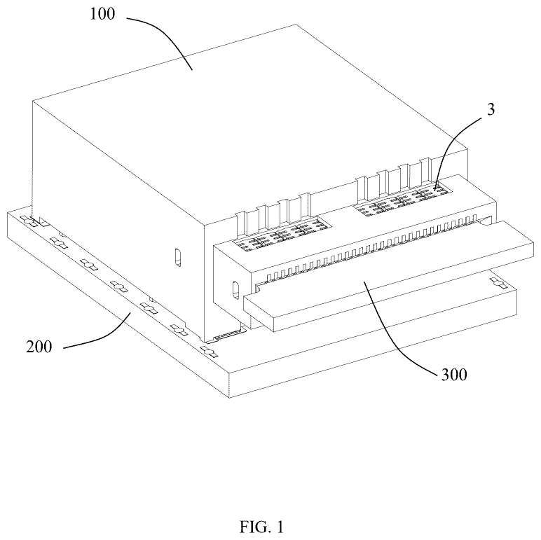

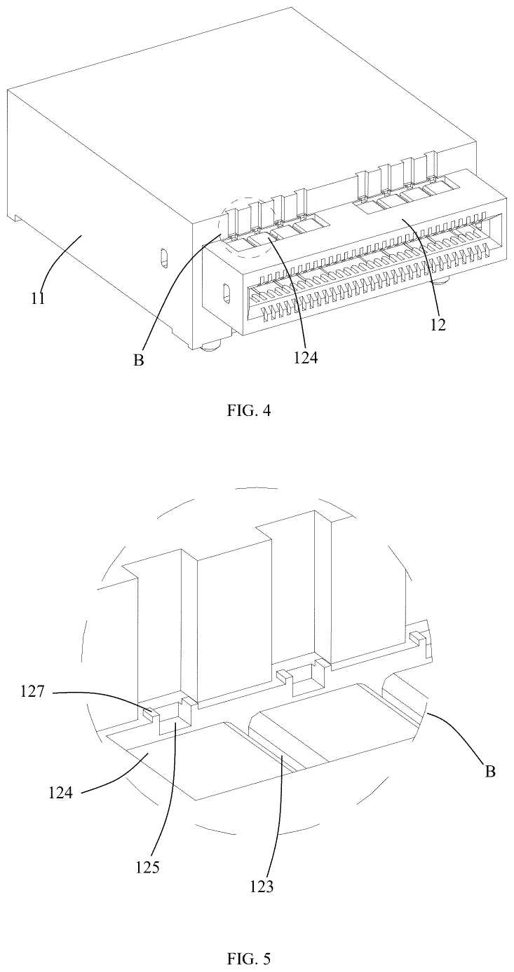

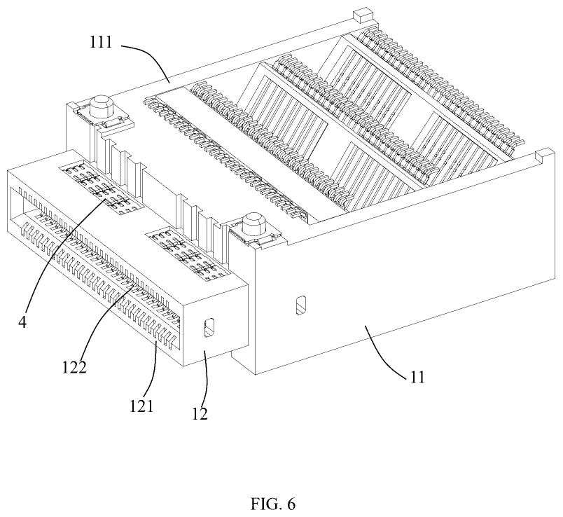

Referring to FIG. 1 to FIG. 20, the present disclosure discloses an electrical connector assembly, including a circuit board 200, an electrical connector 100 mounted on the circuit board 200, and a mating module 300 for mating with the electrical connector 100.

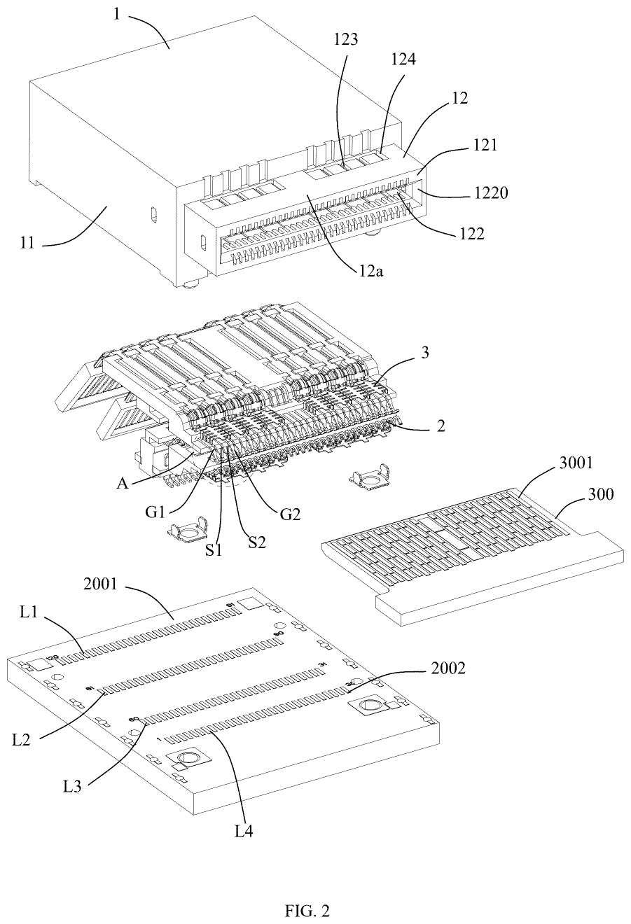

Referring to FIG. 2, in an illustrated embodiment of the present disclosure, the circuit board 200 includes an upper surface 2001 and a plurality of soldering pads 2002 located on the upper surface 2001. The plurality of soldering pads 2002 are disposed in a first row L1, a second row L2, a third row L3 and a fourth row L4 which are in parallel with one another.

Referring to FIG. 2, the mating module 300 is a mating circuit board or a mating connector. In the illustrated embodiment of the present disclosure, the mating module 300 is the mating circuit board. The mating circuit board includes a plurality of mating conductive pads 3001 located on upper and lower surfaces thereof.

Referring to FIG. 2, the electrical connector 100 includes an insulating body 1, a terminal module 2 installed in the insulating body 1, and a grounding component. The grounding component is mounted at least partially on the insulating body 1. By providing the grounding component, it is beneficial to improve the grounding effect of the terminal module 2. In the illustrated embodiment of the present disclosure, referring to FIG. 2 to FIG. 7, the insulating body 1 includes a base portion 11 and a plug-in portion 12 connected with the base portion 11. The base portion 11 includes a mounting surface 111 which is used to be mounted on the upper surface 2001 of the circuit board 200. The plug-in portion 12 includes a mating surface 121 and a mating slot 122 that extends through the mating surface 121. The mating slot 122 is configured to receive the mating module 300. The plug-in portion 12 includes an upper wall portion 12a and a lower wall portion 12b disposed opposite to the upper wall portion 12a. Each of the upper wall portion 12a and the lower wall portion 12b defines a mounting groove 124 and a mounting hole 123 communicating with the mounting groove 124.

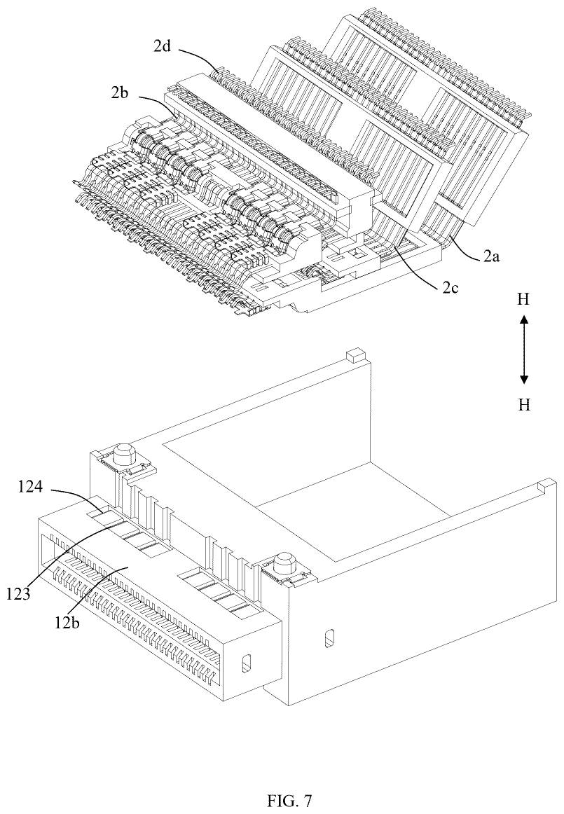

In the illustrated embodiment of the present disclosure, referring to FIG. 7, the terminal module 2 includes a first terminal module 2a, a second terminal module 2b, a third terminal module 2c and a fourth terminal module 2d. The first terminal module 2a and the second terminal module 2b are arranged up and down along a thickness direction H-H of the insulating body 1. The third terminal module 2c and the fourth terminal module 2d are arranged up and down along the thickness direction H-H of the insulating body 1. Of course, in other embodiments, the terminal module 2 may not be provided with the third terminal module 2c and the fourth terminal module 2d. In other words, the terminal module 2 includes only the first terminal module 2a and the second terminal module 2b.

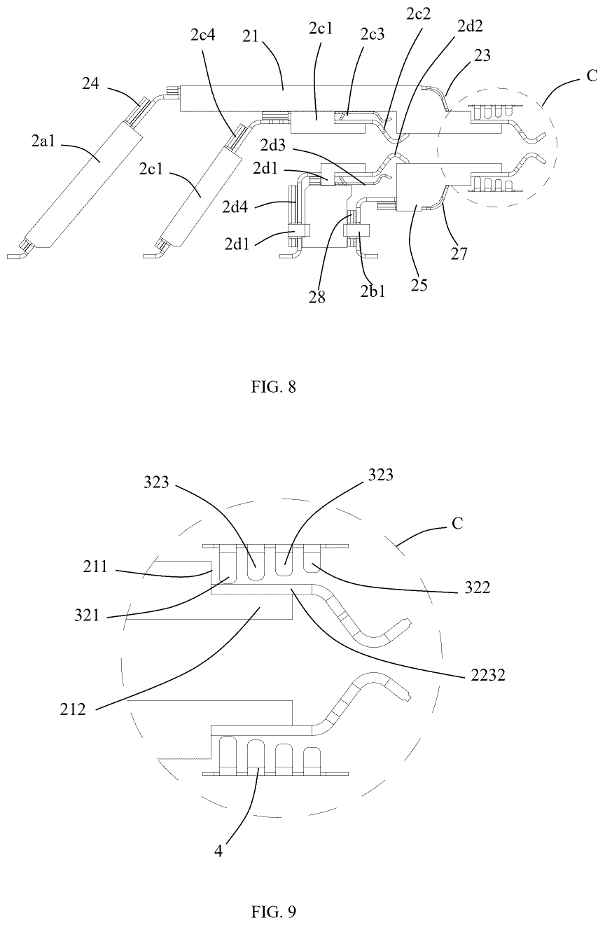

Referring to FIG. 8, the first terminal module 2a includes a first insulating block 2, a fifth insulating block 2a1, a plurality of first conductive terminals arranged on the first insulating block 21 and the fifth insulating block 2a1, a first shielding plate 23 and a second shielding plate 24. The first shielding plate 23 is connected to the first insulating block 21. The second shielding plate 24 is connected to the fifth insulating block 2a1. In the illustrated embodiment of the present disclosure, the first conductive terminals are insert-molded with the first insulating block 21. Of course, in other embodiments, the first conductive terminals may also be fixed to the first insulating block 21 by assembly or the like.

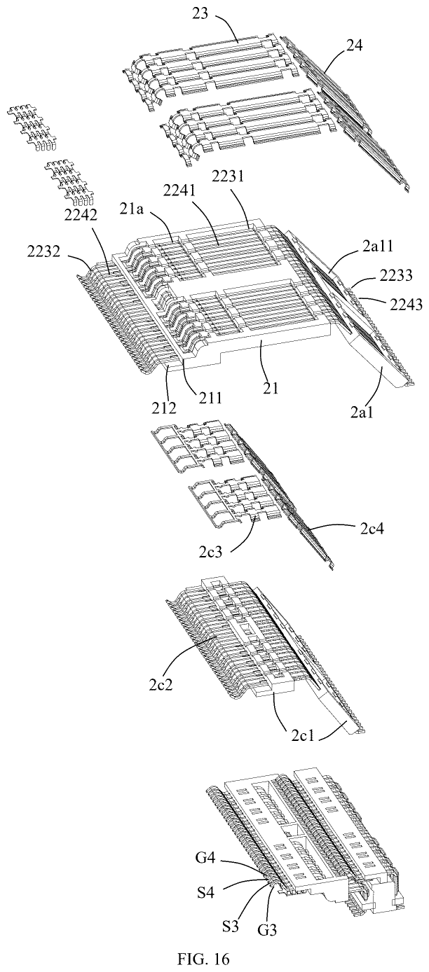

Referring to FIG. 16, the first insulating block 21 includes a first groove 21a. The fifth insulating block 2a1 includes a second groove 2a11. The first conductive terminal includes a mating elastic arm protruding beyond the first insulating block 21 to extend into the mating slot 122, a body portion exposed to the first groove 21a and the second groove 2a11, and a tail portion extending beyond the fifth insulating block 2a1. The first shielding plate 23 is at least partially disposed in the first groove 21a. The second shielding plate 24 is at least partially disposed in the second groove 2a11. The first shielding plate 23 and the second shielding plate 24 jointly shield an outer side of the body portion.

Referring to FIG. 2, the plurality of first conductive terminals include a first signal terminal S1, a second signal terminal S2, a first ground terminal G1 located on one side of the first signal terminal S1 and disposed adjacent to the first signal terminal S1, and a second ground terminal G2 located on one side of the second signal terminal S2 and disposed adjacent to the second signal terminal S2. The first signal terminal S1 and the second signal terminal S2 form differential pair signal terminals. The differential pair signal terminals are located between the first ground terminal G1 and the second ground terminal G2 so as to improve the quality of signal transmission.

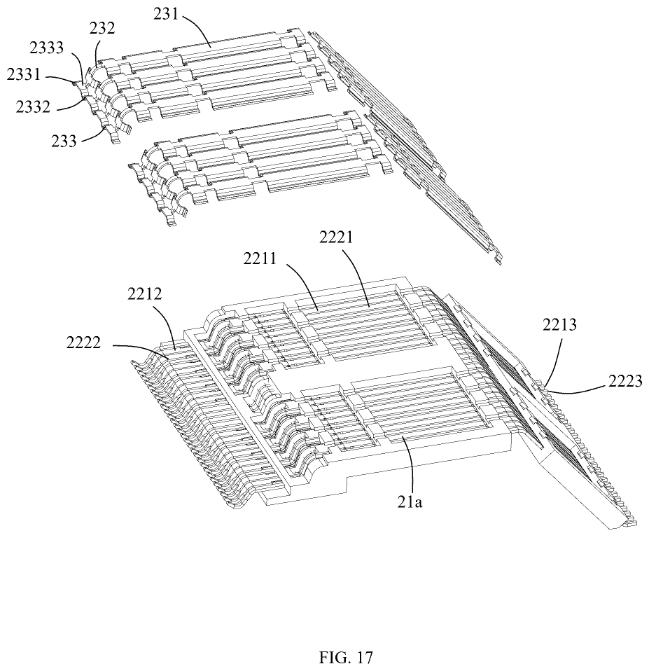

Referring to FIG. 16, the first ground terminal G1 includes a first main body portion 2231, a first elastic arm 2232 connected to one end of the first main body portion 2231 and extending into the mating slot 122, and a first tail portion 2233 connected to another end of the first main body portion 2231. The second ground terminal G2 includes a second main body portion 2241, a second elastic arm 2242 connected to one end of the second main body portion 2241 and extending into the mating slot 122, and a second tail portion 2243 connected to another end of the second main body portion 2241. Referring to FIG. 17, the first signal terminal S1 includes a fifth main body portion 2211, a fifth elastic arm 2212 connected to one end of the fifth main body portion 2211 and extending into the mating slot 122, and a fifth tail portion 2213 connected to another end of the fifth main body portion 2211. The second signal terminal S2 includes a sixth main body portion 2221, a sixth elastic arm 2222 connected to one end of the sixth main body portion 2221 and extending into the mating slot 122, and a sixth tail portion 2223 connected to another end of the sixth main body portion 2221. The first elastic arm 2232, the second elastic arm 2242, the fifth elastic arm 2212 and the sixth elastic arm 2222 are all configured to mate with the mating module 300. The first tail portion 2233, the second tail portion 2243, the fifth tail portion 2213 and the sixth tail portion 2223 are configured to be connected to the circuit board 200.

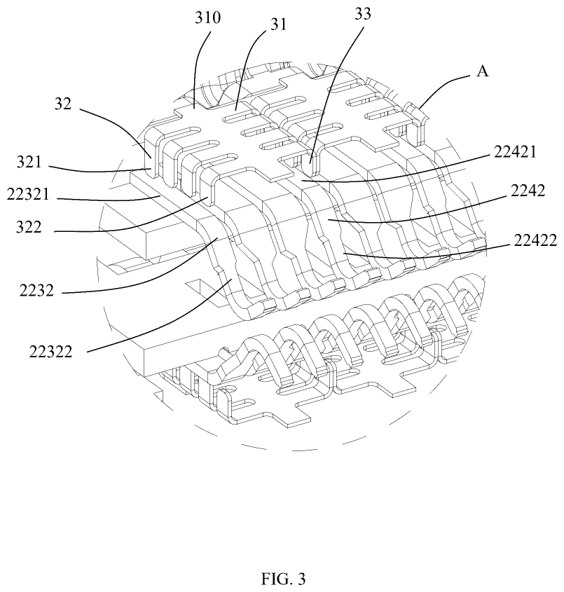

Specifically, referring to FIG. 3, the first elastic arm 2232 includes a first arm portion 22321 connected to the first main body portion 2231, and a first mating portion 22322 connected to the first arm portion 22321. The second elastic arm 2242 includes a second arm portion 22421 connected to the second main body portion 2241, and a second mating portion 22422 connected to the second arm portion 22421.

Referring to FIG. 8, the second terminal module 2b includes a second insulating block 25, a sixth insulating block 2b1, a plurality of second conductive terminals arranged on the second insulating block 25 and the sixth insulating block 2b1, a third shielding plate 27 and a fourth shielding plate 28. The third shielding plate 27 is connected to the second insulating block 25. The fourth shielding plate 28 is connected to the sixth insulating block 2b1. The third shielding plate 27 and the fourth shielding plate 28 jointly shield outer sides of the plurality of second conductive terminals. In the illustrated embodiment of the present disclosure, the second conductive terminals are insert-molded with the second insulating block 25. Of course, in other embodiments, the second conductive terminals may also be fixed to the second insulating block 25 by assembly or the like.

Referring to FIG. 16, the plurality of second conductive terminals include a third signal terminal S3, a fourth signal terminal S4, a third ground terminal G3 located on one side of the third signal terminal S3 and disposed adjacent to the third signal terminal S3, a fourth ground terminal G4 located on one side of the fourth signal terminal S4 and disposed adjacent to the fourth signal terminal S4. The third signal terminal S3 and the fourth signal terminal S4 form differential pair signal terminals. The differential pair signal terminals are located between the third ground terminal G3 and the fourth ground terminal G4 to improve the quality of signal transmission.

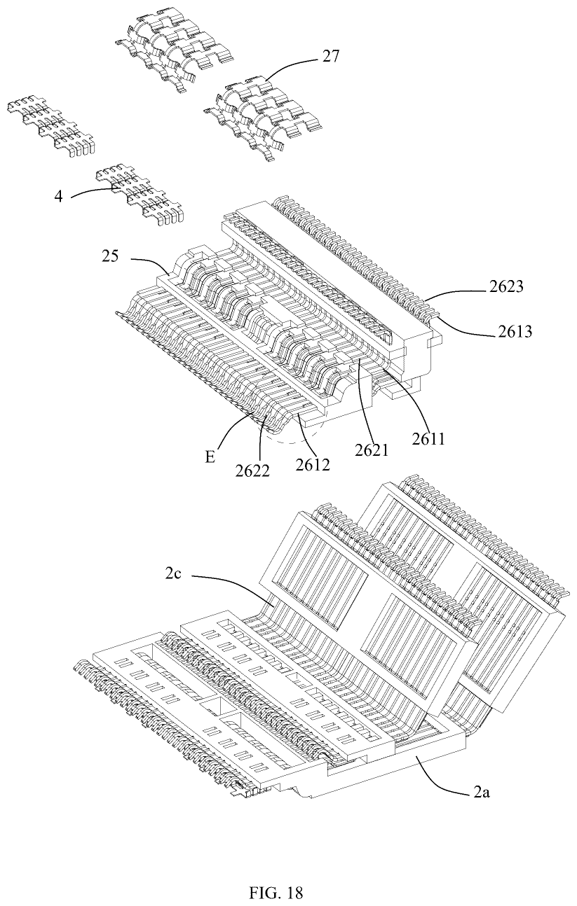

Referring to FIG. 18, the third ground terminal G3 includes a third main body portion 2611, a third elastic arm 2612 connected to one end of the third main body portion 2611 and extending into the mating slot 122, and a third tail portion 2613 connected to another end of the third main body portion 2611. The fourth ground terminal G4 includes a fourth main body portion 2621, a fourth elastic arm 2622 connected to one end of the fourth main body portion 2621 and extending into the mating slot 122, and a fourth tail portion 2623 connected to another end of the fourth main body portion 2621. The third elastic arm 2612 and the fourth elastic arm 2622 are both configured to mate with the mating module 300. The third tail portion 2613 and the fourth tail portion 2623 are configured to be connected to the circuit board 200.

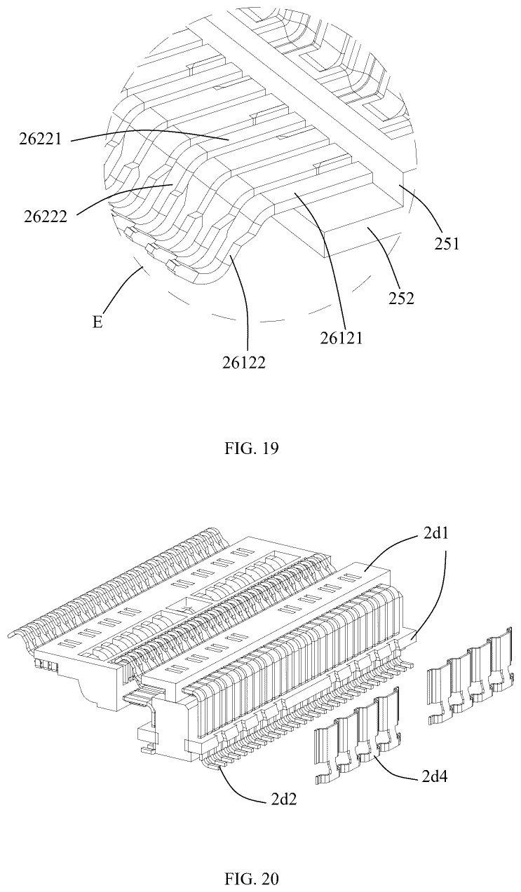

Specifically, referring to FIG. 19, the third elastic arm 2612 includes a third arm portion 26121 connected to the third main body portion 2611, and a third mating portion 26122 connected to the third arm portion 26121. The fourth elastic arm 2622 includes a fourth arm portion 26221 connected to the fourth main body portion 2621, and a fourth mating portion 26222 connected to the fourth arm portion 26221.

Referring to FIG. 9 and FIG. 16, the first insulating block 21 includes a first end face 211 and a first protrusion 212 protruding beyond the first end face 211. The first protrusion 212 is configured to support the first arm portion 22321 of the first elastic arm 2232 and the second arm portion 22421 of the second elastic arm 2242. The first protrusion 212 supports the first arm portion 22321 and the second arm portion 22421 which are in an unmated state, thereby reducing the deformation of the first mating portion 22322 and the second mating portion 22422 in a direction close to the second terminal module 2b. Referring to FIG. 19, the second insulating block 25 includes a second end face 251 and a second boss 252 protruding beyond the second end face 251. The second boss 252 is configured to support the third arm portion 26121 of the third elastic arm 2612 and the fourth arm portion 26221 of the fourth elastic arm 2622. The second boss 252 supports the third arm portion 26121 and the fourth arm portion 26221 which are in an unmated state, thereby reducing the deformation of the third arm portion 26122 and the fourth arm portion 26222 in a direction close to the first terminal module 2a.

Referring to FIG. 8 and FIG. 16, the third terminal module 2c includes two third insulating blocks 2c1, a plurality of third conductive terminals 2c2 arranged on the two third insulating blocks 2c1, a fifth shielding plate 2c3 and a sixth shielding plate 2c4. The fifth shielding plate 2c3 and the sixth shielding plate 2c4 are mounted on the two third insulating blocks 2c1, respectively. The fifth shielding plate 2c3 and the sixth shielding plate 2c4 jointly shield outer sides of the plurality of third conductive terminals 2c2. Referring to FIG. 8 and FIG. 20, the fourth terminal module 2d includes two fourth insulating blocks 2d1, a plurality of fourth conductive terminals 2d2 arranged on the two fourth insulating blocks 2d1, a seventh shielding plate 2d3 and an eighth shielding plate 2d4. The seventh shielding plate 2d3 and the eighth shielding plate 2d4 jointly shield outer sides of the plurality of fourth conductive terminals 2d2.

The third shielding plate 27 is similar to the first shielding plate 23, and the following will be described in detail only by taking the first shielding plate 23 as an example.

The first shielding plate 23 is made of a metal material. Referring to FIG. 17, the first shielding plate 23 includes a shielding body 231, a plurality of elastic arm portions 232 extending from the shielding body 231, and a plurality of fixing portions 233 connected to the plurality of elastic arm portions 232. The plurality of elastic arm portions 232 are arranged at intervals along a width direction of the first shielding plate 23. The shielding body 231 is at least partially received in the first groove 21a. The fixing portion 233 includes a first fixing portion 2331 fixed to the first main body portion 2231 of the first ground terminal G1, a second fixing portion 2332 fixed to the second main body portion 2241 of the second ground terminal G2, and a bridge portion 2333 connecting the first fixing portion 2331 and the second fixing portion 2332. The bridge portion 2333 is overheaded on the fifth main body portion 2211 of the first signal terminal S1 and the sixth main body portion 2221 of the second signal terminal S2, so that the bridge portion 2333 is not in contact with the first signal terminal S1 and the second signal terminal S2 to avoid short circuits. The first fixing portion 2331 and the second fixing portion 2332 are both flat plate-shaped. The bridge portion 2333 is generally U-shaped. The first fixing portion 2331, the second fixing portion 2332 and the bridge portion 2333 are generally S-shaped as a whole.

The grounding component includes a first grounding component 3 and a second grounding component 4. The first grounding component 3 cooperates with the first terminal module 2a. The second grounding component 4 cooperates with the second terminal module 2b. The first grounding component 3 is generally U-shaped. Referring to FIG. 3, the first grounding component 3 includes a body portion 31, a first side portion 32 bent and extending from one side of the body portion 31, and a second side portion 33 bent and extending from another side of the body portion 31. Referring to FIG. 5, two ends of the body portion 31 are provided with retaining portions 310. The insulating body 1 defines a retaining slot 125. The retaining portion 310 is received in the retaining slot 125. An edge of the retaining slot 125 has a protrusion 127 formed by hot melt material. The protrusion 127 is hot melted and flows into the retaining slot 125, and is formed in the retaining slot 125 to encapsulate the retaining portion 310, so that the first grounding component 3 is fixed to the insulating body 1.

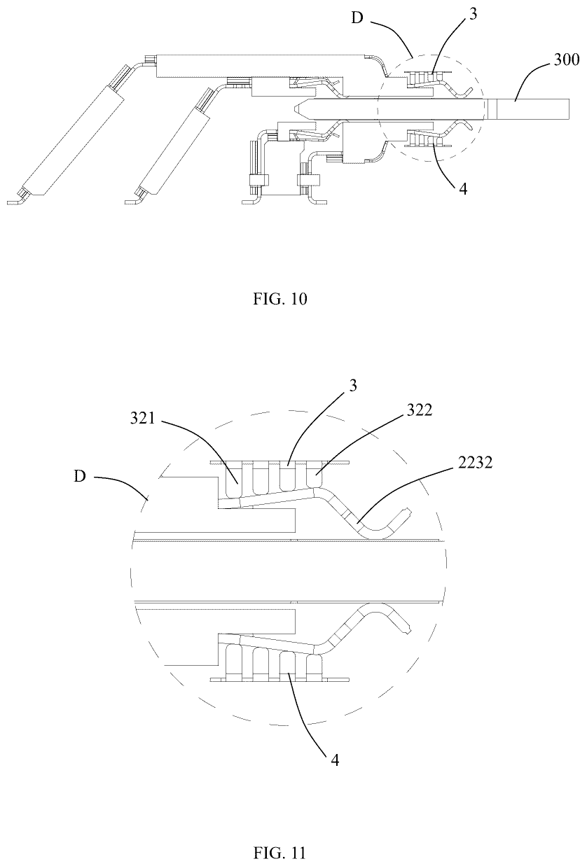

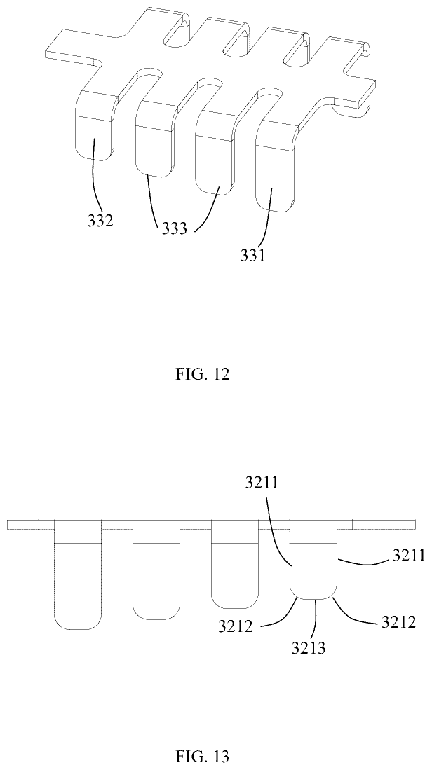

Referring to FIG. 3 and FIG. 9, the first side portion 32 includes a first contact portion 321 and a second contact portion 322. The first contact portion 321 and the second contact portion 322 are formed by bending and extending from one side of the body portion 31. Referring to FIG. 10 and FIG. 11, the first contact portion 321 and the second contact portion 322 are both configured to be in contact with the first arm portion 22321 of the first elastic arm 2232 which is in a mated state. Referring to FIG. 12, the second side portion 33 includes a third contact portion 331 and a fourth contact portion 332. The third contact portion 331 and the fourth contact portion 332 are both configured to be in contact with the second arm portion 22421 of the second elastic arm 2242 which is in a mated state.

Specifically, the first contact portion 321 extends beyond the second contact portion 322 in a thickness direction H-H of the insulating body 1. That is, a length of the second contact portion 322 extending beyond the body portion 31 in the thickness direction H-H of the insulating body 1 is smaller than a length of the first contact portion 321 extending beyond the body portion 31. As a result, in the first contact portion 321 and the second contact portion 322, at least the second contact portion 322 is separated from the first elastic arm 2232 which is in an unmated state. This reduces contact between the first grounding component 3 and the first elastic arm 2232 in the unmated state. During the mating process of the first elastic arm 2232, the deformation of the second contact portion 322 can be reduced. The third contact portion 331 extends beyond the fourth contact portion 332 in the thickness direction H-H of the insulating body 1. That is, a length of the fourth contact portion 332 extending beyond the body portion 31 in the thickness direction H-H of the insulating body 1 is smaller than a length of the third contact portion 331 extending beyond the body portion 31. As a result, in the third contact portion 331 and the fourth contact portion 332, at least the fourth contact portion 332 is separated from the second elastic arm 2242 which is in an unmated state. This reduces contact between the first grounding component 3 and the second elastic arm 2242 in the unmated state. During the mating process of the second elastic arm 2242, the deformation of the fourth contact portion 332 can be reduced.

The mating slot 122 includes an insertion port 1220 for plugging the mating module 300. The second contact portion 322 is disposed closer to the insertion port 1220 than the first contact portion 321. The fourth contact portion 332 is disposed closer to the insertion port 1220 than the third contact portion 331. In the illustrated embodiment of the present disclosure, the first contact portion 321 is separated from the first elastic arm 2232 which is in the unmated state. The third contact portion 331 is separated from the second elastic arm 2242 which is in the unmated state. That is, when the first terminal module 2a is in an unmated state, the first side portion 32 of the first grounding component 3 does not come into contact with the first elastic arm 2232, and the second side portion 33 does not come into contact with the second elastic arm 2242. During the mating process of the first terminal module 2a, deformation of the first side portion 32 and the second side portion 33 can be reduced.

In a first embodiment of the present disclosure, the first contact portion 321 and the second contact portion 322 are arranged at intervals along a plug-in direction of the mating module 300. The third contact portion 331 and the fourth contact portion 332 are arranged at intervals along the plug-in direction of the mating module 300. With this arrangement, the first grounding component 3 can form point contact with the first elastic arm 2232 and the second elastic arm 2242, thereby enhancing the contact effect.

Referring to FIG. 9, the first side portion 32 includes at least one fifth contact portion 323 between the first contact portion 321 and the second contact portion 322. The fifth contact portion 323 extends beyond the second contact portion 322 in the thickness direction H-H of the insulating body 1. The first contact portion 321 extends beyond the fifth contact portion 323 in the thickness direction H-H of the insulating body 1. The second side portion 33 includes at least one sixth contact portion 333 located between the third contact portion 331 and the fourth contact portion 332. The sixth contact portion 333 extends beyond the fourth contact portion 332 in the thickness direction H-H of the insulating body 1. The third contact portion 331 extends beyond the sixth contact portion 333 in the thickness direction H-H of the insulating body 1. By providing the fifth contact portion 323 and the sixth contact portion 333, the first grounding component 3 forms multi-point contact with the first elastic arm 2232 and the second elastic arm 2242, so that the crosstalk performance is optimized. In the illustrated embodiment of the present disclosure, the first side portion 32 includes two fifth contact portions 323. The first contact portion 321, the two fifth contact portions 323 and the second contact portion 322 are arranged at intervals and distributed in a step-like manner, so as to facilitate multi-point contact with the first elastic arm 2232 in the mating state. The second side portion 33 includes two sixth contact portions 333. The third contact portion 331, the two sixth contact portions 333 and the fourth contact portion 332 are arranged at intervals and distributed in a step-like manner, so as to facilitate multi-point contact with the second elastic arm 2242 in the mating state.

The first contact portion 321, the second contact portion 322, the third contact portion 331, the fourth contact portion 332, the fifth contact portion 323 and the sixth contact portion 333 are all perpendicular to the body portion 31. In the illustrated embodiment of the present disclosure, referring to FIG. 13, each of the first contact portion 321, the second contact portion 322 and the fifth contact portion 323 includes two side surfaces 3211, two transition surfaces 3212 connected to the two side surfaces 3211, and a bottom surface 3213 connecting the two transition surfaces 3212. The bottom surface 3213 is a plane or an arc-shaped surface. The transition surface 3212 is an arc-shaped surface.

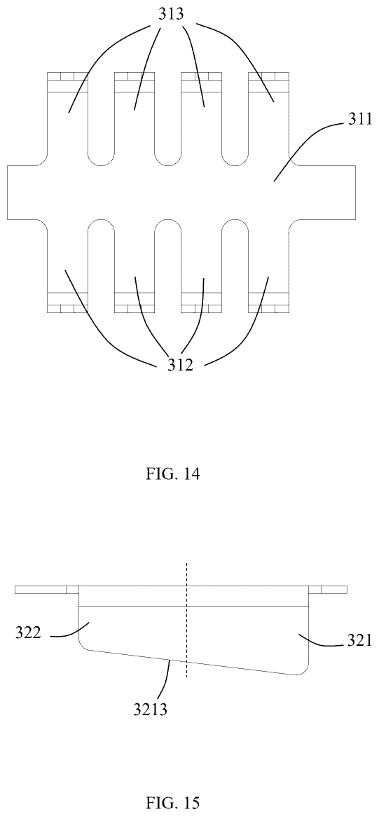

Referring to FIG. 14, the body portion 31 includes a support portion 311, a plurality of first connecting portions 312 extending outward from one side of the support portion 311, and a plurality of second connecting portions 313 extending outward from another side of the support portion 311. The plurality of the first connecting portions 312 are arranged at intervals along the plug-in direction of the mating module 300. The plurality of the second connecting portions 313 are arranged at intervals along the plug-in direction of the mating module 300. The first connecting portions 312 are correspondingly connected to the first contact portion 321, the second contact portion 322 and the fifth connecting portion 323. The plurality of the second connecting portions 313 are correspondingly connected to the third contact portion 331, the fourth contact portion 332 and the sixth connecting portion 333. The retaining portion 310 extends outwardly from two ends of the support portion 311.

In an illustrated second embodiment of the present disclosure, the first side portion 32 is in a flat shape. Referring to FIG. 15, the first contact portion 321 and the second contact portion 322 are integrally arranged in the plug-in direction of the mating module 300. A bottom surface of the first contact portion 321 is connected to a bottom surface of the second contact portion 322, and together forms an abutment surface 3213 arranged to contact the first elastic arm 2232. The abutment surface 3213 is an inclined surface, which facilitates the abutment surface 3213 to contact the first arm portion 22321 in the mating state, and at the same time reduces deformation of the first side portion 32.

In the illustrated embodiment of the present disclosure, the plurality of first conductive terminals include a plurality of differential pair signal terminals. Two sides of each of the differential pair signal terminals is associated with one first ground terminal G1 and one second ground terminal G2. Accordingly, the electrical connector 100 is provided with a plurality of the first grounding components 3. Each of the first grounding components 3 is configured to be in contact with one of the first ground terminals G1 and one of the second ground terminals G2. The adjacent first grounding components 3 may be connected or may be disposed at intervals.

The second grounding component 4 and the first grounding component 3 have the same structure. The first contact portion 321 and the second contact portion 322 of the second grounding component 4 are both configured to contact the third elastic arm 2612 which is in the mated state. The third contact portion 331 and the fourth contact portion 332 of the second grounding component 4 are both configured to contact the fourth elastic arm 2622 in the mated state. The detailed structure of the second grounding component 4 will not be described in detail.

The body portion 31 of the first grounding component 3 is provided in the mounting groove 124 of the upper wall portion 12a. The first contact portion 321 and the second contact portion 322 of the first grounding component 3 both pass through the mounting hole 123 of the upper wall portion 12a and extend into the mating slot 122. The body portion 31 of the second grounding component 4 is provided in the mounting groove 124 of the lower wall portion 12b. The first contact portion 321 and the second contact portion 322 of the second grounding component 4 both pass through the mounting hole 123 of the lower wall portion 12b and extend into the mating slot 122.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. An electrical connector, comprising:
an insulating body, the insulating body comprising a mating surface and a mating slot extending through the mating surface;
a terminal module, the terminal module being provided on the insulating body, the terminal module comprising a first signal terminal and a first ground terminal which is located on one side of the first signal terminal and disposed adjacent to the first signal terminal; the first ground terminal comprising a first elastic arm extending into the mating slot; the first elastic arm being configured to mate with a mating module; and
a first grounding component, the first grounding component being at least partially disposed on the insulating body; the first grounding component comprising a first contact portion and a second contact portion; the first contact portion extending beyond the second contact portion in a thickness direction of the insulating body; in the first contact portion and the second contact portion, at least the second contact portion being separated from the first elastic arm which is in an unmated state; the first contact portion and the second contact portion being both configured to contact the first elastic arm which is in a mated state.

2. The electrical connector according to claim 1, wherein the first contact portion is separated from the first elastic arm which is in the unmated state.

3. The electrical connector according to claim 1, wherein the mating slot comprises an insertion port for plugging the mating module, and the second contact portion is disposed closer to the insertion port than the first contact portion in a plug-in direction of the mating module.

4. The electrical connector according to claim 1, wherein the first grounding component comprises a body portion; the first contact portion and the second contact portion are both bent and extended from one side of the body portion; the insulating body defines a mounting groove and a mounting hole in communication with the mounting groove; the body portion is disposed in the mounting groove; both the first contact portion and the second contact portion pass through the mounting hole and extend into the mating slot.

5. The electrical connector according to claim 4, wherein the terminal module comprises a second signal terminal and a second ground terminal which is located on one side of the second signal terminal and disposed adjacent to the second signal terminal; the first signal terminal and the second signal terminal form differential pair signal terminals which are located between the first ground terminal and the second ground terminal; the second ground terminal comprises a second elastic arm extending into the mating slot;
the first grounding component comprises a third contact portion and a fourth contact portion which are bent from another side of the body portion; the third contact portion extends beyond the fourth contact portion in the thickness direction of the insulating body; in the third contact portion and the fourth contact portion, at least the fourth contact portion is separated from the second elastic arm which is in an unmated state; the third contact portion and the fourth contact portion are both configured to be in contact with the second elastic arm which is in a mated state.

6. The electrical connector according to claim 4, wherein the body portion comprises a retaining portion; the insulating body defines a retaining slot in which the retaining portion is received; an edge of the retaining slot comprises a protrusion formed by hot melt material; the protrusion is hot melted and flows into the retaining slot and is formed in the retaining slot to encapsulate the retaining portion.

7. The electrical connector according to claim 1, wherein the first contact portion and the second contact portion are spaced apart in a plug-in direction of the mating module.

8. The electrical connector according to claim 7, wherein the first grounding component comprises at least one fifth contact portion located between the first contact portion and the second contact portion; the fifth contact portion extends beyond the second contact portion in the thickness direction of the insulating body; the first contact portion extends beyond the fifth contact portion in the thickness direction of the insulating body.

9. The electrical connector according to claim 1, wherein the first contact portion and the second contact portion are integrally arranged in a plug-in direction of the mating module; a bottom surface of the first contact portion is connected to a bottom surface of the second contact portion so as to form an abutment surface which is arranged to be in contact with the first elastic arm; the abutment surface is an inclined surface.

10. The electrical connector according to claim 1, wherein the terminal module comprises a first insulating block which comprises a first end face and a first protrusion protruding beyond the first end face; the first protrusion is configured to support the first elastic arm.

11. An electrical connector, comprising:
an insulating body, the insulating body comprising a mating surface and a mating slot extending through the mating surface; the mating slot being configured to receive a mating module along a plug-in direction;
a terminal module, the terminal module being at least partially coupled to the insulating body, the terminal module comprising a first signal terminal and a first ground terminal which is located on one side of the first signal terminal; the first ground terminal comprising a first elastic arm extending into the mating slot; the first elastic arm being configured to mate with the mating module along the plug-in direction; and
a first grounding component, the first grounding component being at least partially disposed on the insulating body; the first grounding component comprising a first contact portion and a second contact portion; the first contact portion and the second contact portion extending in different heights in a thickness direction of the insulating body; the thickness direction being perpendicular to the plug-in direction;
wherein in the first contact portion and the second contact portion, when the mating module is in an unmated status with the electrical connector, at least the second contact portion is separated from the first elastic arm; and when the mating module is in a mated status with the electrical connector, the first contact portion and the second contact portion are both configured to contact the first elastic arm.

12. The electrical connector according to claim 11, wherein when the mating module is in the unmated status with the electrical connector, the first contact portion is separated from the first elastic arm.

13. The electrical connector according to claim 11, wherein the first contact portion extends beyond the second contact portion along the thickness direction of the insulating body, so that the first contact portion is disposed closer to the mating slot than the second contact portion.

14. The electrical connector according to claim 11, wherein the mating slot comprises an insertion port for plugging the mating module, and the second contact portion is disposed closer to the insertion port than the first contact portion in the plug-in direction.

15. The electrical connector according to claim 11, wherein the first grounding component comprises a body portion; the first contact portion and the second contact portion are both bent and extended from one side of the body portion; the insulating body defines a mounting groove and a mounting hole in communication with the mounting groove; the body portion is disposed in the mounting groove; both the first contact portion and the second contact portion pass through the mounting hole and extend into the mating slot.

16. The electrical connector according to claim 15, wherein the terminal module comprises a second signal terminal and a second ground terminal which is located on one side of the second signal terminal; the first signal terminal and the second signal terminal form differential pair signal terminals which are located between the first ground terminal and the second ground terminal; the second ground terminal comprises a second elastic arm extending into the mating slot;
the first grounding component comprises a third contact portion and a fourth contact portion which are bent from another side of the body portion; the third contact portion extends beyond the fourth contact portion in the thickness direction of the insulating body; in the third contact portion and the fourth contact portion, when the mating module is in the unmated status with the electrical connector, at least the fourth contact portion is separated from the second elastic arm; and when the mating module is in the mated status with the electrical connector, the third contact portion and the fourth contact portion are both configured to be in contact with the second elastic arm.

17. The electrical connector according to claim 15, wherein the body portion comprises a retaining portion; the insulating body defines a retaining slot in which the retaining portion is received; an edge of the retaining slot comprises a protrusion formed by hot melt material; the protrusion is hot melted and flows into the retaining slot and is formed in the retaining slot to encapsulate the retaining portion.

18. The electrical connector according to claim 11, wherein the first contact portion and the second contact portion are integrally arranged in the plug-in direction of the mating module; a bottom surface of the first contact portion is connected to a bottom surface of the second contact portion so as to form an abutment surface which is arranged to be in contact with the first elastic arm; the abutment surface is an inclined surface.

19. The electrical connector according to claim 11, wherein the terminal module comprises a first insulating block which comprises a first end face and a first protrusion protruding beyond the first end face; the first protrusion is configured to support the first elastic arm.

20. An electrical connector, comprising:
an insulating body, the insulating body comprising a mating surface and a mating slot extending through the mating surface; the mating slot being configured to receive a mating module along a plug-in direction;
a terminal module, the terminal module being at least partially coupled to the insulating body, the terminal module comprising a first signal terminal and a first ground terminal located on one side of the first signal terminal; the first ground terminal comprising a first elastic arm extending into the mating slot in a cantilevered manner; the first elastic arm being configured to mate with the mating module along the plug-in direction; and
a first grounding component, the first grounding component being at least partially disposed on the insulating body; the first grounding component comprising a first contact portion, a second contact portion and at least one intermediate contact portion disposed between the first contact portion and the second contact portion along the plug-in direction; the first contact portion, the at least one intermediate contact portion and the second contact portion extending in different heights in a thickness direction of the insulating body; the thickness direction being perpendicular to the plug-in direction;
wherein the first contact portion extends beyond the at least one intermediate contact portion along the thickness direction, and the at least one intermediate contact portion extends beyond the second contact portion along the thickness direction;
wherein the at least one intermediate contact portion and the second contact portion are not in contact with the first elastic arm in a first status when the mating module is not inserted into the mating slot; and
wherein the first contact portion, the at least one intermediate contact portion and the second contact portion are configured to be in contact with the first elastic arm in a second status when the mating module is inserted in the mating slot.
